(19) United States
(12) Patent Application Publication
(10) Pub. No.: US 2007/0137410 A1
(43) Pub. Date: Jun. 21, 2007

(54) Contouring pad for shaping bicycle handlebars

(75) Inventor: Liang-Fu Chang, Taichung Hsien (TW)

Correspondence Address: BROWDY AND NEIMARK, P.L.L.C.;624 NINTH STREET, NW, SUITE 300, WASHINGTON, DC, 20001-5303, US

(73) Assignee: International Bicycle Products Corporation, Taichung Hsein (TW)

(21) Appl. No.: 11/270,644

(22) Filed: Nov. 10, 2005

(51) Int. Cl. B62K 21/26

(52) U.S. Cl. 74/551.9

(57) ABSTRACT

A contouring pad for shaping a bicycle handlebar includes a backing member and a liner member. The backing member is made of a first resilient material having a predetermined hardness to form the whole contour of the pad. The backing member has an accommodating portion therein. The liner member is made of a second resilient member having a hardness being less than that of the first resilient material. The liner member is retained in the accommodating portion.

### BACKGROUND OF THE INVENTION

1. Field of the Invention

The present invention relates generally to bicycle handlebars, more particularly, to a contouring pad for shaping a bicycle handlebar.

2. Description of the Related Art

Riding a racing bicycle and gripping a rigid unshaped handlebar for an extended time can cause fatigue and even numbness of the hands and arms. For creating a more comfortable bicycle handlebar, U.S. Pat. No. 5,280,735 has been disclosed an apparatus for shaping a bicycle handlebar. The apparatus has pads placed on the handlebar and enclosed thereon by tapes wrapped about the forms. Thus the shape of the handlebar can be customized to the needs of the bicycle rider. The pads may be moved and the tape rewrapped thereover when desired.

Such an apparatus mentioned above has a problem that for being made only from a single material, the pads would be too soft or hard to achieve the effect that the apparatus wants to provide.

Thus, it would be desirable to provide a contouring pad that has a suitable character for creating and shaping a more comfortable bicycle handlebar.

### SUMMARY OF THE INVENTION

According to the present invention, a contouring pad for shaping a bicycle handlebar includes a backing member made of a first resilient material having a predetermined hardness to form the whole contour of the pad. The backing member has at least an accommodating portion therein. A liner member made of a second resilient member having a hardness being less than that of the first resilient material is retained in the accommodating portion.

In a preferred embodiment the backing member has an inner surface conforming with the outer surface of a bicycle handlebar and an outer surface conforming with at least a portion of the human hand.

In another preferred embodiment the accommodating portion of the backing member is a chamber. The liner is shaped according to the contour of the chamber for being received therein.

### BRIEF DESCRIPTION OF THE DRAWINGS

These and further features of the present invention will be apparent with reference to the following description and drawings, wherein:

FIG. 1 is a plan view of a bicycle handlebar with a pad for shaping thereof mounted thereon in accordance with the present invention;

FIG. 2 is a top perspective view of the pad embodiment shown in FIG. 1;

FIG. 3 is an exploded view of the pad shown in FIG. 1;

FIG. 4 is a cross-sectional view taken along the line 4-4 of FIG. 1;

FIG. 5 is a bottom perspective view of a backing member of another pad embodiment in accordance with the present invention;

FIG. 6 is a plan view of a bicycle handlebar with another pad for shaping thereof mounted thereon in accordance with the present invention;

FIG. 7 is an exploded view of the pad shown in FIG. 6; and

FIG. 8 is a bottom perspective view of a backing member of the pad shown in FIG. 6.

### DETAILED DESCRIPTION OF THE INVENTION

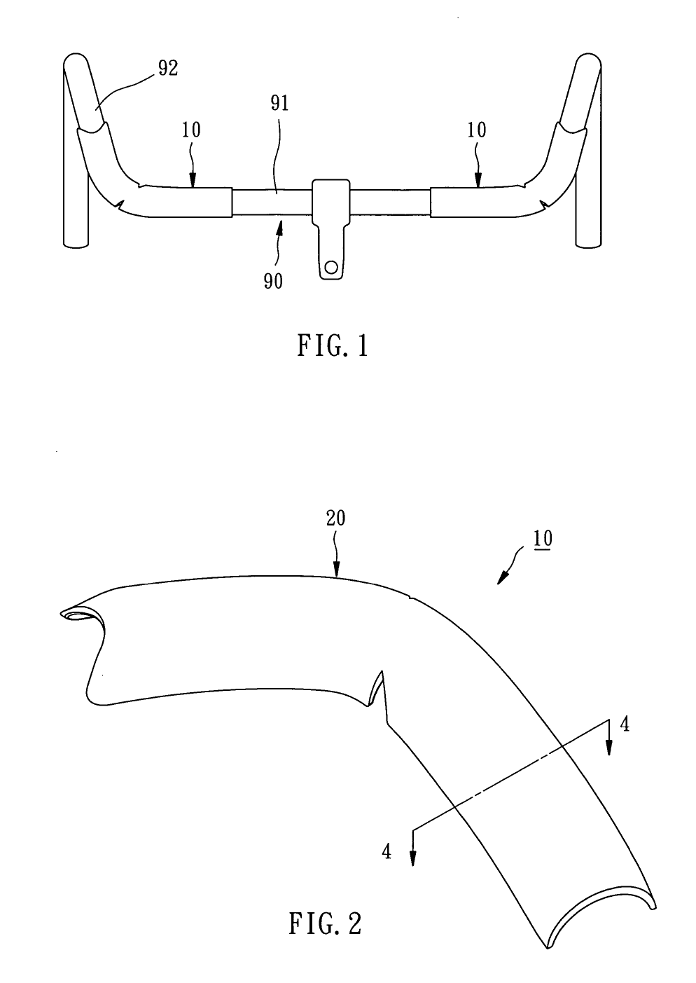

FIG. 1 shows a pad embodiment 10 in accordance with the present invention. The pad 10 is “L” shaped and mounted on the crossover and gradual bend positions 91 and 92 of a racing bicycle handlebar 90. In practice, the pad 10 is enclosed thereon by tapes (not shown) wrapped about the handlebar 90.

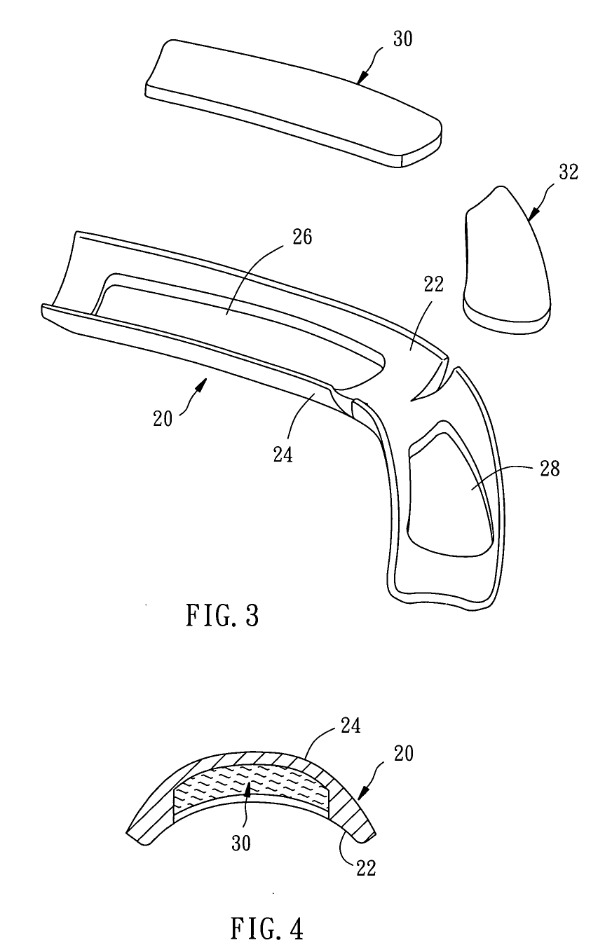

FIGS. 2-4 show the detailed structure of the pad 10. The pad 10 includes a backing member 20 having two accommodating portions and a first and second liner members 30, 32 respectively retained in each of the accommodating portions.

The backing member 20 can be made of a first resilient material which has a suitable hardness such as rubber, urethane foam, or polyurethane foam to form the whole contour of the pad 10. In the present embodiment, the backing member 20 is made of polyurethane foam.

The backing member 20 has an inner surface 22 conforming with the outer surface of the bicycle handlebar 90 and an outer surface 24 conforming with at least a portion of the human hand. In the present embodiment, the accommodating portions are chambers 26, 28 formed on the portions of the inner surface 22 corresponding to the positions of the bicycle handlebar gripped by human hand when riding a racing bicycle.

The liner members 30, 32 can be made of a second resilient material which is softer than the first resilient materials such as plastic gel. In the present embodiment, the liner member 30, 32 are made of polyurethane gel. The liner member 30, 32 are shaped to correspond to the chambers 26, 28 and are received therein.

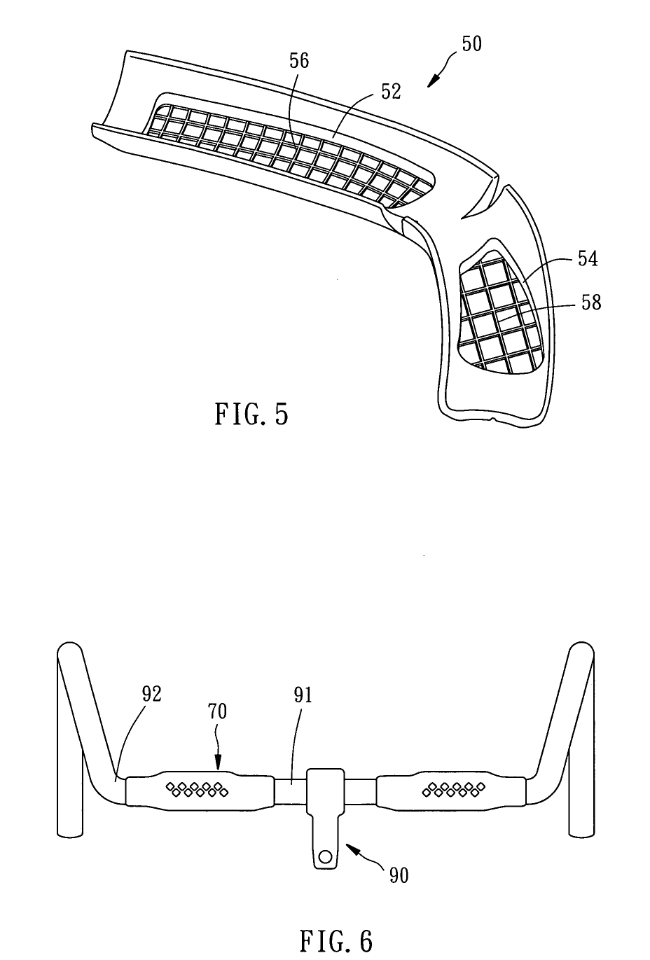

FIG. 5 shows a bottom perspective view of a backing member 50 of a second pad embodiment. The difference between the backing member 50 and the backing member 20 of the pad 10 is that the former has chambers 52, 54 with a meshed bottom wall 56, 58 to firmly retain the liner members (not shown).

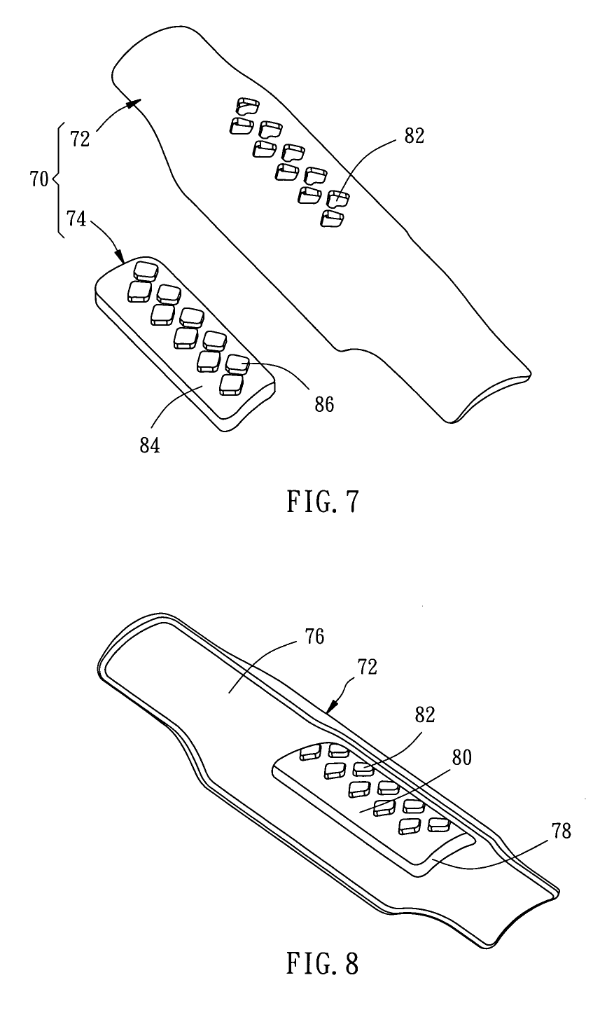

A third pad embodiment 70 in accordance with the present invention is shown in FIG. 6 to FIG. 8. The pad 70 is “half-cylinder” shaped and mounted on the crossover position 91 of the racing bicycle handlebar 90. The pad 70 is also combined by a backing member 72 made of polyurethane foam and a liner member 74 made of polyurethane gel.

The backing member 72 has an inner surface 76 with a recess 78 to receive the liner member 74. The recess 78 has a bottom wall 80 provided with a plurality of openings 82. The liner member 74 has a top surface 84 with a plurality of protrudes 86. The liner member 74 is received in the recess 78 in such a way that each of the protrudes 86 pierces respectively through each of openings 82.

As mentioned above, for having the backing member with a suitable hardness to form the whole contour of the pad, and the liner members having a hardness less than that of the backing member received in the portions of the backing member corresponding to the positions of the bicycle handlebar that are gripped by a rider's hand when riding a racing bicycle, the pad 10 can create and shape a more comfortable bicycle handlebar.

What is claimed is:

1. A contouring pad for shaping a bicycle handlebar, comprising:
a backing member made of a first resilient material having a predetermined hardness to form the whole contour of said pad, said backing member defining at least an accommodating portion therein; and
a liner member made of a second resilient member having a hardness being less than that of said backing member and retained in said accommodating portion.

2. A contouring pad as defined in claim 1 wherein said backing member has an inner surface conforming with the outer surface of a bicycle handlebar and an outer surface conforming with at least a portion of the human hand.

3. A contouring pad as defined in claim 2 wherein said accommodating portion is provided at said inner surface of said backing member.

4. A contouring pad as defined in claim 3 wherein said accommodating portion is a chamber to receive said liner member.

5. A contouring pad as defined in claim 1 wherein said accommodating portion has at least an opening, said liner member has at least a protrude piercing through said opening.

6. A contouring pad as defined in claim 4 wherein said chamber has a bottom wall with at least an opening, said liner member has an upper surface with at least a protrude and is received in said chamber in such a way that said protrude pierces through said opening.

7. A contouring pad as defined in claim 4 wherein said chamber has a bottom wall with a meshed structure.

8. A contouring pad as defined in claim 1 wherein said first resilient material is a polyurethane foam.

9. A contouring pad as defined in claim 1 wherein said second resilient material is a polyurethane gel.
